(19) United States
(12) Patent Application Publication
(10) Pub. No.: US 2010/0177610 A1
(43) Pub. Date: Jul. 15, 2010

(54) OPTICAL DISK DEVICE FOR MULTI-LAYER OPTICAL DISK AND MULTI-LAYER OPTICAL DISK

(76) Inventor: Takahiro MATSUDA, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/582,747

(22) Filed: Oct. 21, 2009

(30) Foreign Application Priority Data
Jan. 9, 2009 (JP) 2009-003510

(51) Int. Cl. G11B 20/18; G11B 3/74

(52) U.S. Cl. 369/53.17; 369/94; G9B/7

(57) ABSTRACT

An optical disk device for writing data into a disk including a plurality of recording layers, wherein the disk includes a recording layer in which a track for recording the data is formed in a clockwise spiral direction, and a recording layer in which a track for recording the data is formed in a counter-clockwise spiral direction, and the optical disk device records the data into a first recording layer, and selects a layer in which the data can be recorded and of which a spiral direction is opposite to the spiral direction of the first recording layer, as a recording layer for recording the data next to the first recording layer.

### CLAIM OF PRIORITY

The present application claims priority from Japanese patent application JP2009-3510 filed on Jan. 9, 2009, the content of which is hereby incorporated by reference into this application.

### BACKGROUND OF THE INVENTION

The present invention relates to an optical disk device and a multi-layer disk, and in particular, to an optical disk device and a multi-layer disk which determine a sequence of the data recording to a recording layer and the data reproduction in consideration of a spiral direction of tracks in the multi-layer disk.

With regards to optical disks, two layer disks having two recording layers are put in practical use. As to the two layer disks, the spiral direction of a track in a first layer is from the inner periphery to the outer periphery, and the spiral direction of a track in a second layer is from the outer periphery to the inner periphery. The data is recorded in order of the first layer and the second layer.

Moreover, with regards to optical disks, a multi-layer disk having three or more recording layers has been proposed (see JP3841468B2). In this multi-layer disk, a recording layer having a counter-clockwise spiral track, and a recording layer having a clockwise spiral track are arranged alternately.

### SUMMARY OF THE INVENTION

In such a multi-layer disk, in order not to move the pickup from the outer periphery to the inner periphery (or from the inner periphery to the outer periphery) at the time of the layer change, it is desirable to record the data in a sequence, from the inner periphery to the outer periphery, the layer change, from the outer periphery to the inner periphery, and the layer change.

However, since the spiral direction of the track in each layer of the optical disk is determined in the stage of manufacturing the optical disk, the sequence for recording data onto the recording layer is also determined in the stage of manufacturing the optical disk.

In this case, as in the conventional two layer disks, if the data is recorded in a sequence starting from a backmost (or most front) recording layer, a big movement of the pickup does not happen at the time of the layer change. However, there is a need to select a plurality of recording layers freely for recording data.

For example, in a case where one recording layer is skipped for recording data, if the recording sequence is from the inner periphery to the outer periphery, followed by the layer change, it becomes necessary to move the pickup to the inner periphery because the spiral direction in the track of the recording layer recorded next is from the inner periphery to the outer periphery. When skipping one layer for recording continuous information, there is a problem in that it needs time to move the pickup, and consequently, takes time in writing data.

Moreover, if continuous information is recorded by skipping one layer, it needs time to move the pickup upon the reproduction, and it is necessary to have a data buffer for that amount of time.

The objective of the present invention is to provide an optical disk device and a multi-layer disk which do not change the recording layer and do not make a big movement in the radial direction when recording continuous information onto a multi-layer disk and reproducing it.

In an optical disk device for writing data into a disk including a plurality of recording layers according to a representative embodiment of this invention, the disk includes a recording layer in which a track for recording the data is formed in a clockwise spiral direction, and a recording layer in which a track for recording the data is formed in a counter-clockwise spiral direction, and the optical disk device records the data into a first recording layer, and selects a layer in which the data can be recorded and of which a spiral direction is opposite to the spiral direction of the first recording layer, as a recording layer for recording the data next to the first recording layer.

Moreover, the optical disk device according to another example of the present invention is an optical disk device which reads data from a disk including a plurality of recording layers, wherein the disk includes a recording layer in which a track for recording the data is formed in a clockwise spiral direction, and a recording layer in which a track for recording the data is formed in a counter-clockwise spiral direction; and the optical disk device reads the data from a first recording layer, and selects a layer which has a spiral direction opposite to the spiral direction of the first recording layer, as a recording layer for reproducing the data next to the first recording layer, based on management information recorded in the disk.

The multi-layer disk according to an example of the present invention includes a plurality of recording layers, and comprises a recording layer in which a track for recording data is formed in a clockwise spiral direction, a recording layer in which a track for recording the data is formed in a counter-clockwise spiral direction, and a region for recording information on the spiral direction of each recording layer.

According to the optical disk device of the embodiment of the present invention, it becomes possible to avoid a big movement in the radial direction in a multi-layer disk at the time of the change of the recording layer.

### BRIEF DESCRIPTION OF THE DRAWINGS

The present invention can be appreciated by the description which follows in conjunction with the following figures, wherein:

FIG. 1 is a block diagram showing the constitution of an optical disk device according to a first embodiment of the present invention;

FIG. 2 is a flow chart of the processing in which the optical disk device selects a layer for writing data based on defect information according to the first embodiment of the present invention;

FIG. 3 is a diagram illustrating an arrangement of recording layer sequence information according to the first embodiment of the present invention;

FIG. 4 is a diagram illustrating recording layer sequence information according to the first embodiment of the present invention;

FIG. 5 is a diagram illustrating a sequence of the recording to the optical disk according to the first embodiment of the present invention;

FIG. 6 is a diagram illustrating another recording layer sequence information according to the first embodiment of the present invention;

FIG. 7 is a diagram illustrating the sequence of the recording into the optical disk according to the first embodiment of the present invention;

FIG. 8 is a diagram showing another recording layer sequence information according to the first embodiment of the present invention;

FIG. 9 is a diagram showing another recording layer sequence information according to the first embodiment of the present invention;

FIG. 10 is a flow chart of the processing in which the optical disk device according to the modification example of the first embodiment of the present invention records information on the next recording layer in the last of each recording layer;

FIG. 11 is a diagram illustrating an arrangement of the next recording layer information in the modification example of the first embodiment of the present invention;

FIG. 12 is a flow chart of the processing in which the optical disk device according to the modification example of the first embodiment of the present invention selects the recording layer using information on the next recording layer of the last recorded recording layer among the recording layers, and reproduces the data in the selected recording layer;

FIG. 13 is a flow chart of processing in which the optical disk device according to the first embodiment of the present invention reproduces data recorded in the address specified by converting the logical address to the physical address;

FIG. 14 is a diagram illustrating a conversion of the address of the optical disk device according to the first embodiment of the present invention;

FIG. 15 is a diagram illustrating the correspondence between a logical address and a physical address in the case shown in FIG. 14;

FIG. 16 is a diagram illustrating another correspondence between the logical address and the physical address in the case shown in FIG. 14;

FIG. 17 is a flow chart of the processing for selecting the recording layer based on the recording quality during the recording by the optical disk device according to a second embodiment of the present invention;

FIG. 18 is a diagram illustrating the sequence of the recording into the optical disk according to the second embodiment of the present invention; and

FIG. 19 is a diagram illustrating another recording layer sequence information according to the second embodiment of the present invention.

### DETAILED DESCRIPTION OF THE PREFERRED EMBODIMENT

### First Embodiment

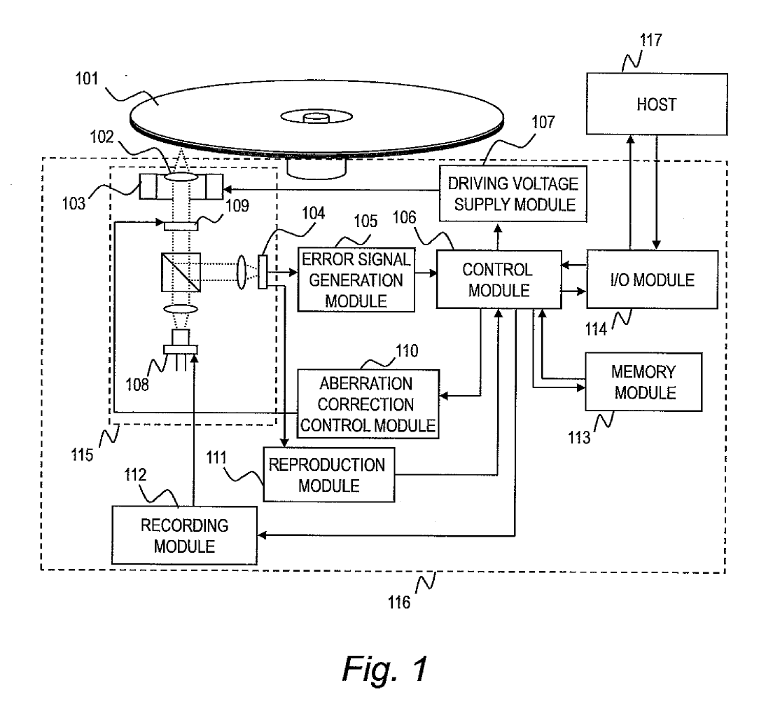

FIG. 1 is a block diagram showing the constitution of an optical disk device according to the first embodiment of the present invention.

The optical disk device 116 according to the embodiment of the present invention can be loaded with an optical disk 101 and comprises an optical head 115, an error signal generation module 105, a control module 106, a driving voltage supply module 107, an aberration correction control module 110, a reproduction module 111, a recording module 112, a memory module 113, and an I/O (input and output) module 114.

The optical disk 101 is rotated by being driven with a disk motor.

The optical head 115 comprises an objective lens 102, a moving module 103, an optical receiver 104, a laser 108, and an aberration correction mechanism 109.

The laser 108 is a semiconductor laser (light emitting unit) which generates laser light of a predetermined intensity for the recording and the reproduction. The laser light emitted from the laser 108 is irradiated onto the recording surface (the optical disk surface) of the optical disk 101 through the objective lens 102. The optical receiver 104 receives through the objective lens 102 the laser light reflected onto the recording surface of the optical disk 101, converts the received reflected light into an electric signal, and outputs the converted electric signal. The objective lens 102 is driven with the moving module (actuator) 103, and is adjusted so that the laser light focuses onto the optical disk surface. The moving module 103 is driven by the driving voltage supply module 107.

For example, in the case where data is written to or read from a multi-layer disk, the objective lens 102 is driven so that the laser light focuses onto the recording layer which the data is written into or read from.

The aberration correction mechanism 109 is, for example, a liquid crystal element, provided to correct the aberration of the lens (e.g., objective lens 102), and is controlled by the aberration correction control module 110 to change the phase of the transmitted light.

The error signal generation module 105 generates an error signal upon movement of the objective lens 102. Based on the error signal, the laser light is adjusted so that it focuses onto a predetermined recording surface.

The control module 106 controls the operation of the optical disk device 116. For example, the control module 106 processes to control the intensity of the laser light output from the laser 108, the focal position of the laser light and so on. The memory module 113 is a memory which stores programs executed by the control unit 106 and data required for the execution of the programs.

The driving voltage supply module 107 drives the moving module (actuator) 103 for moving the objective lens 102.

The reproduction module 111 converts the signal generated by the optical receiver 104 based on the laser light which is reflected on the recording surface of the optical disk 101, and reproduces the data recorded in the optical disk 101. Moreover, the reproduction module 111 is provided with a reproduction data buffer which temporarily stores the data read-ahead from the optical disk 101.

The recording module 112 generates data for writing into the optical disk 101 from data received from a host computer 117. Moreover, the recording module 112 is provided with a recording data buffer which temporarily stores the data which should be recorded into the optical disk 101.

The input and output module 114 is an interface with the host computer 117. For example, ATA (Advanced Technology Attachment) interface is used.

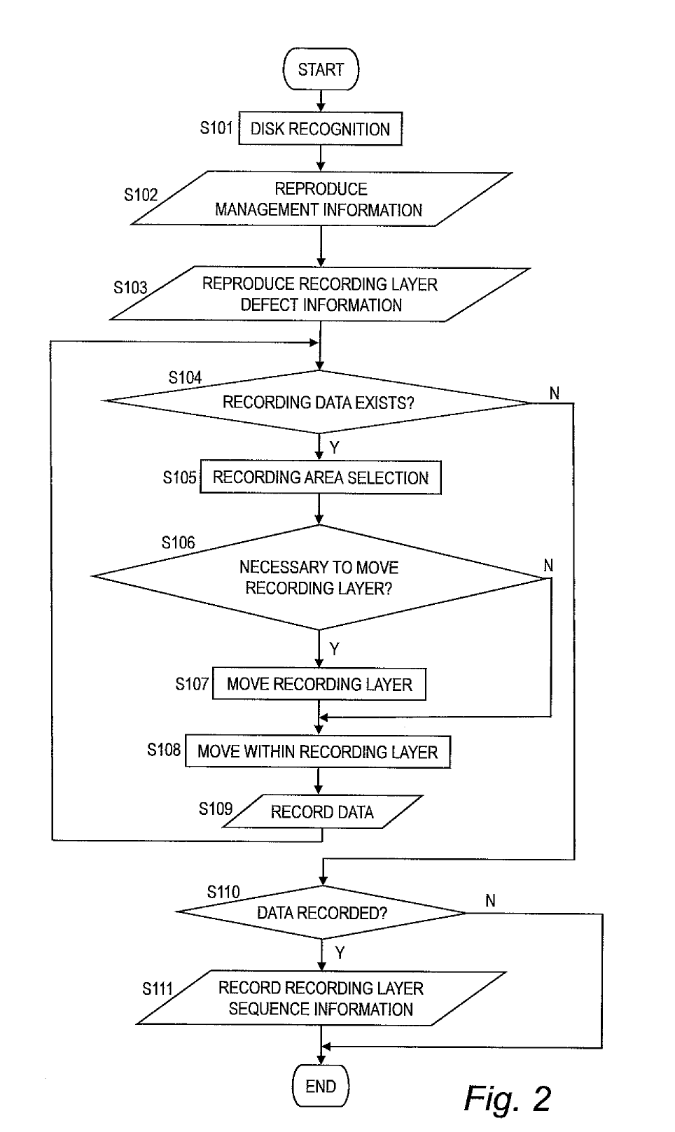

FIG. 2 is a flow chart of the processing in which the optical disk device 116 selects a layer for writing data based on defect information, according to the first embodiment of the present invention.

The control module 106 recognizes that the optical disk 101 is loaded onto the optical disk device 116 by means of the reflected laser light, and determines a type of the loaded optical disk 101 (S101). For example, the depth of the recording layer, that is, the type of the optical disk, can be determined from the position where the reflected light can be obtained by moving the objective lens 102 with the moving module 103. Thereafter, management information is reproduced from the management region defined according to the determined type of the optical disk (S102), and the recording layer defect information recorded into a predetermined position of the management region is reproduced (S103). This recording layer defect information indicates whether each recording layer included in the optical disk 101 cannot be used due to including defects.

Then, the control module 106 determines whether the data which should be recorded into the optical disk 101 is stored in the recording data buffer or not (S104).

If the data which should be recorded into the optical disk 101 is stored in the recording data buffer, the region for recording the data is selected (S105).

In selecting the recording region, in a recording layer (recording layer A) including the region where the data is recorded most recently, if there is a region where user data can be recorded immediately after the region where the data is recorded most recently, that region is selected. If there is no recordable region, another recording layer is selected. Upon selecting the recording layer, the selection is done based on several conditions. The first condition is that the recording layer has a spiral direction opposite to the spiral direction of the above-described recording layer A based on the information on the spiral direction of the track in each layer included in the management information reproduced at step S102. The second condition is that the recording layer includes a recordable region where user data can be recorded. The third condition is that the recording layer is closest to the recording layer A among the recording layers satisfying the first and the second conditions.

A fourth condition may be added to the above conditions. The fourth condition is that the recording layer does not have defects, which can be judged based on the defect information reproduced at step S103. In this case, the third condition is that the recording layer is closest to the recording layer A among the recording layers satisfying the first, the second and the fourth conditions.

Thereafter, the control module 106 determines whether it is necessary to move the recording layer from the selected recording layer to another recording layer or not (S106), and if necessary, it is moved to another recording layer (S107). Furthermore, if it is needed to move within the recording layer, it is moved within the recording layer (S108). Then, the data is recorded into the selected region (S109), and the process returns to step S104, and it is determined again whether the data which should be recorded into the optical disk 101 is stored or not.

On the other hand, if it is determined that the data which should be recorded into the optical disk 101 is not stored in the recording data buffer at step S104, the control module 106 determines whether data has been newly written onto the optical disk 101 or not (S110). If the data has been written, the recording layer sequence information which indicates the sequence for recording the data onto the recording layer is recorded into the management region (S111). It is noted that although the recording layer sequence information is written after the recording for all data is completed (e.g., immediately before the disk ejection) in the processing shown in FIG. 2, the recording layer sequence information may be written per a fixed quantity of recording (e.g., one recording layer).

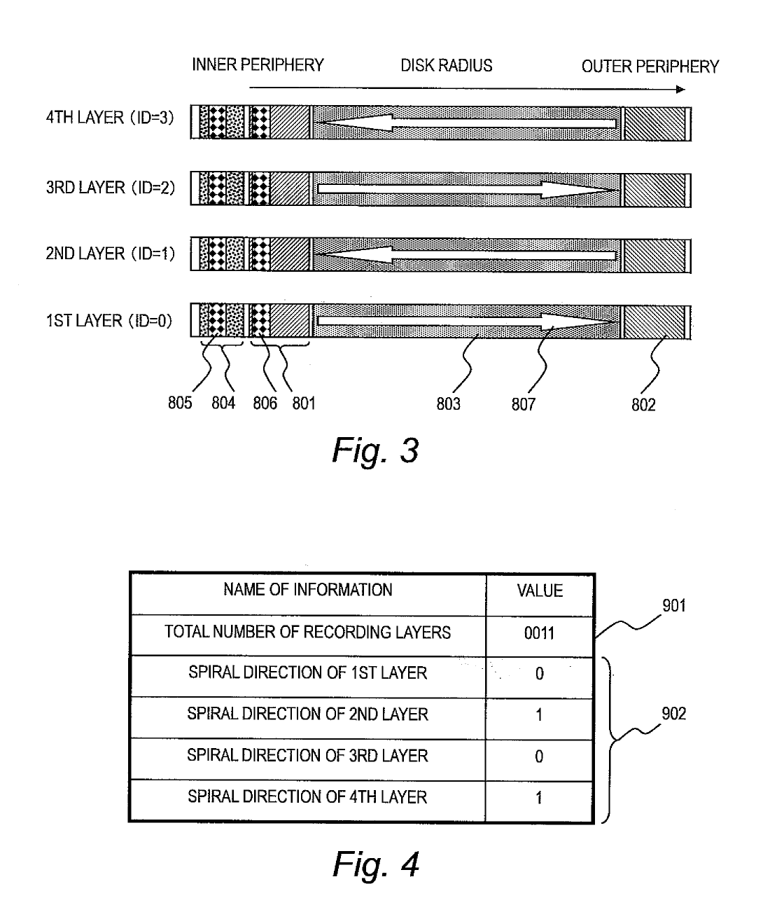

FIG. 3 is a diagram illustrating an arrangement of the recording layer sequence information according to the first embodiment of the present invention.

The optical disk (BD disk) shown in FIG. 3 includes four recording layers, a first layer (ID=0) to a fourth layer (ID=3), and tracks in adjacent layers are formed spirally in opposite directions. That is, tracks in the first layer and the third layer are formed in a direction from the inner periphery to the outer periphery, and tracks in the second layer and the fourth layer are formed in a direction from the outer periphery to the inner periphery.

A BCA (burst cutting area) region 804 is provided in the innermost periphery of each layer, an inner periphery management information region 801 is provided in the outside of the BCA region 804, and an outer periphery management information region 802 is provided in the outermost periphery. It is noted that the BCA region 804 need not be formed in all of the recording layers. Moreover, in a case where the BCA region 804 is formed only in one recording layer, the data need not be recorded on other recording layers in the radial position in which the BCA region 804 is formed.

A user data region 803 is formed between the inner periphery management region 801 and the outer periphery management region 802. It is noted that the arrows 807 illustrated in the user data region 803 in FIG. 3 show the recording directions of the user data.

Recording layer sequence information 805 and 806 is recorded into the BCA region 804 or the inner periphery management region 801. The recording layer sequence information 805 and 806 should be recorded in more than one place among the eight illustrated places.

Moreover, the recording layer spiral information which indicates the spiral direction of the track in each recording layer may be included in the recording layer sequence information.

FIG. 4 is a diagram illustrating the recording layer sequence information according to the first embodiment of the present invention.

The recording layer sequence information shown in FIG. 4 includes information on the total number of the recording layers 901, and information on the spiral direction in each recording layer 902.

The information on the total number of the recording layers 901 consists of, for example, 4-bit data, and “0000” is recorded if one recording layer is included in the optical disk and “0011” is recorded if four recording layers are included in the optical disk.

The number of pieces of the information on the spiral direction in the recording layer 902 is the same as the number of the recording layers included in this optical disk. The information on the spiral direction in the recording layer 902 consists of, for example, 1-bit data, wherein “0” is recorded if the spiral direction is the direction in which information continues from the inner periphery to the outer periphery, and “1” is recorded if the spiral direction is the direction in which information continues from the outer periphery to the inner periphery.

For example, since four recording layers are included in the optical disk shown in FIG. 3, “0011” is recorded in the total number of the recording layers 901. Moreover, “0” is recorded in the information on the spiral direction 902 for the first layer and the third layer since the track is formed from the inner periphery to the outer periphery, and “1” is recorded in the information on the spiral direction 902 for the second layer and the fourth layer since the track is formed from the outer periphery to the inner periphery.

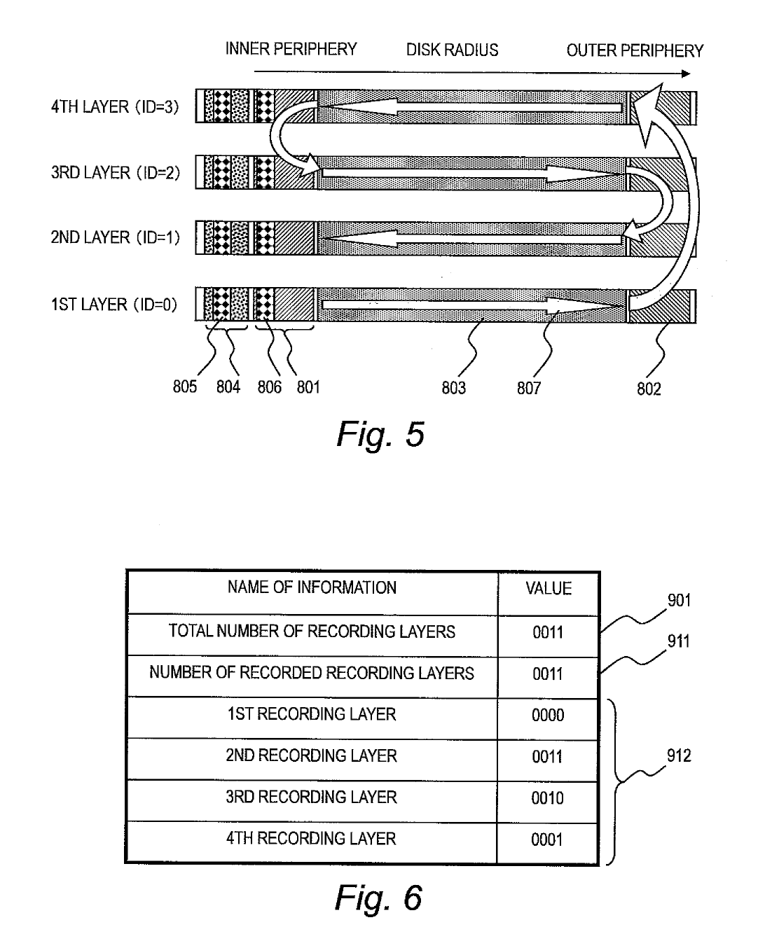

FIG. 5 is a diagram illustrating the sequence of the recording to the optical disk according to the first embodiment of the present invention. FIG. 6 is a diagram illustrating another recording layer sequence information according to the first embodiment of the present invention.

FIG. 6 shows an example of the recording layer sequence information for the optical disk of which the recording layer is used in a sequence of the first layer, the fourth layer, the third layer, followed by the second layer, as shown in FIG. 5.

The recording layer sequence information shown in FIG. 6 includes “the information on the total number of the recording layers 901”, “information on the number of the recorded recording layers 911”, and “information on the sequence for reproducing the recording layer 912”.

The information on the total number of the recording layers 901 consists of, for example, 4-bit data, wherein “0000” is recorded if one recording layer is included in the optical disk and “0011” is recorded if four recording layers are included in the optical disk.

The information on the number of the recorded recording layers 911 indicates the number of the recording layers in which the data is already recorded among the recording layers included in the optical disk, and is recorded in the same form as the information on the total number of the recording layers 901.

The identifier of the recording layer is recorded in the information on the sequence for reproducing the recording layer 912 according to the sequence of the reproduction.

For example, since four recording layers are included in the optical disk shown in FIG. 5, “0011” is recorded into the total number of the recording layers 901. Moreover, since the data is recorded into four recording layers, “0011” is recorded into the number of the recorded recording layers 911.

Moreover, since the recording layer to be reproduced first is the first layer, the identifier of the first layer, “0000”, is recorded into the first recording layer. Since the recording layer to be reproduced next is the fourth layer, the identifier of the fourth layer, “0011”, is recorded into the second recording layer. Since the recording layer to be reproduced next is the third layer, the identifier of the third layer, “0010”, is recorded into the third recording layer. Since the recording layer to be reproduced next is the second layer, the identifier of the second layer, “0001”, is recorded into the fourth recording layer.

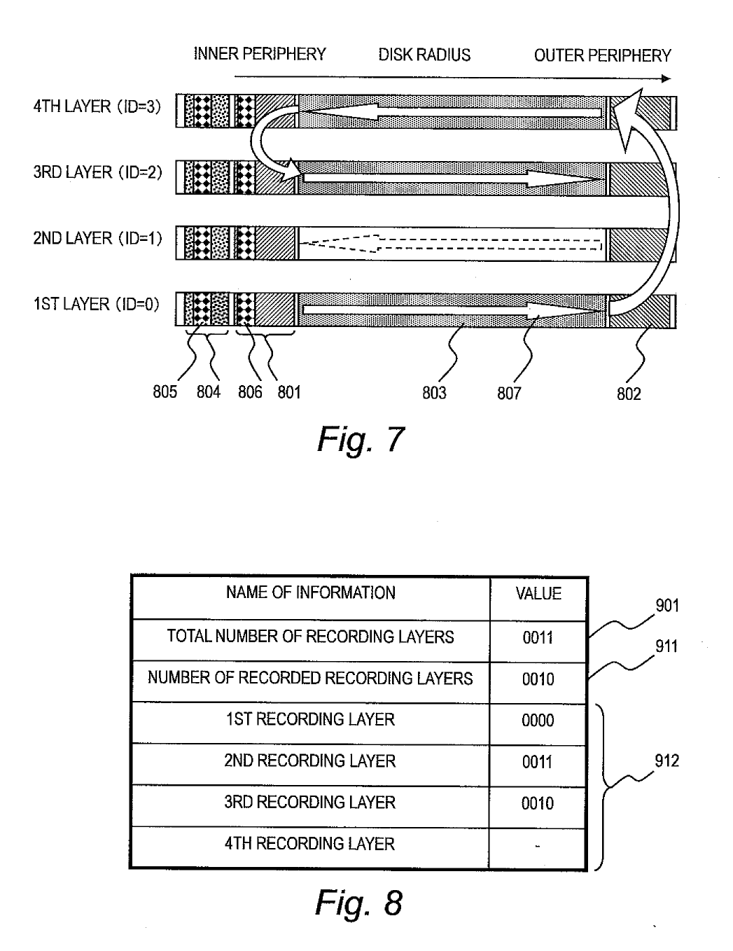

FIG. 7 is a diagram illustrating the sequence of the recording into the optical disk according to the first embodiment of the present invention. FIG. 8 is a diagram showing another recording layer sequence information according to the first embodiment of the present invention.

FIG. 8 shows an example of the recording layer sequence information for the optical disk of which the recording layer is used in an order of the first layer, the fourth layer, followed by the third layer, and the second layer is banned for use as shown in FIG. 7.

The recording layer sequence information shown in FIG. 8 includes “the information on the total number of the recording layers 901”, “the information on the number of the recorded recording layers 911”, and “the information on the sequence for reproducing the recording layer 912”. The recording form for each piece of information is the same as the recording layer sequence information described above in FIG. 6.

For example, since four recording layers are included in the optical disk shown in FIG. 7, “0011” is recorded into the total number of the recording layers 901. Moreover, since the data is recorded into three recording layers, “0010” is recorded into the number of the recorded recording layers 911.

Since the recording layer to be reproduced first is the first layer, the identifier of the first layer, “0000”, is recorded into the first recording layer. Next, since the recording layer to be reproduced next is the fourth layer, the identifier of the fourth layer, “0011”, is recorded into the second recording layer. Since the recording layer to be reproduced next is the third layer, the identifier of the third layer, “0010”, is recorded into the third recording layer. Since there is no recording layer to be reproduced next, the identifier of the recording layer is not recorded into the fourth recording layer.

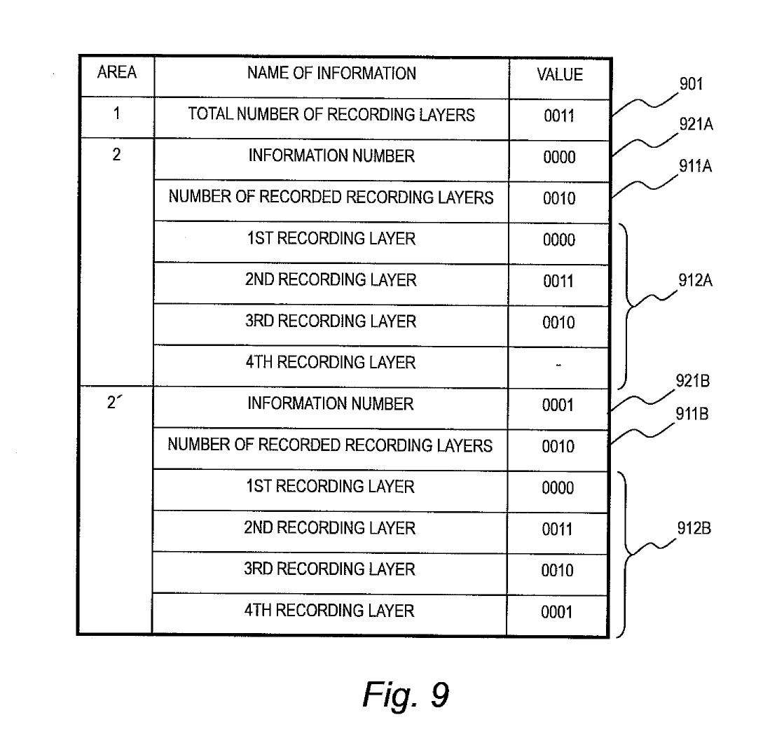

FIG. 9 is a diagram illustrating another recording layer sequence information according to the first embodiment of the present invention.

In write once-optical disks (e.g., disks into which the data can be written one time, such as BD-R and DVD-R), after recording into the management information region, there are cases where the record state of the user area changes. For this reason, in the recording layer sequence information shown in FIG. 9, a plurality of pieces of the information on the number of the recorded recording layers, and the information on the sequence for reproducing the recording layer can be recorded, and the newest information can be identified by giving information numbers to the pieces of the information. That is, a larger value is given to newer pieces of information and a piece of recording layer sequence information which has the largest information number is made valid.

The recording layer sequence information shown in FIG. 9 includes the information on the total number of the recording layers 901, the information numbers 921A and 921B, the information on the number of the recorded recording layers 911A and 911B, and the information on the sequence for reproducing the recording layer 912A and 912B. The information number 921A is an identifier identifying a set of information of the number of the recorded recording layers 911A and information of the sequence for reproducing the recording layer 912A. The recording form of other information is the same as the recording layer sequence information described above in FIG. 6.

For example, in the recording layer sequence information shown in FIG. 9, since four recording layers are included, “0011” is recorded into the total number of the recording layers 901. Moreover, the region 2 having the information number of “0000” and the region 2′ of “0001” are included. It is noted that since the information number of the region 2′ is larger, the information on the region 2′ becomes valid, whereas the information on the region 2 becomes invalid.

That is, the recording layer sequence information of the region 2 is created in a situation where the data is recorded into the first to the third recording layers. After the recording layer sequence information of the region 2 is created, the data is recorded into the fourth recording layer, and the recording layer sequence information of the region 2′ is created.

Since the data is recorded into three recording layers according to the information on the region having the information number 921A of “0000”, “0010” is recorded into the number of the recorded recording layers 911A. As to the information on the sequence for reproducing the recording layer 912A, since the recording layer to be reproduced first is the first layer, the identifier of the first layer, “0000”, is recorded into the first recording layer. Since the recording layer to be reproduced next is the fourth layer, the identifier of the fourth layer, “0011”, is recorded into the second recording layer. Since the recording layer to be reproduced next is the third layer, the identifier of the third layer, “0010”, is recorded into the third recording layer. Since there is no recording layer to be reproduced next, the identifier of the recording layer is not recorded into the fourth recording layer.

Since the data is recorded into four recording layers according to the information on the region having information number 921B of “0001”, “0010” is recorded into the number of the recorded recording layers 911B. As to the information on the sequence for reproducing the recording layer 912B, since the recording layer to be reproduced first is the first layer, the identifier of the first layer, “0000”, is recorded into the first recording layer. Since the recording layer to be reproduced next is the fourth layer, the identifier of the fourth layer, “0011”, is recorded into the second recording layer. Since the recording layer to be reproduced next is the third layer, the identifier of the third layer, “0010”, is recorded into the third recording layer. Since the recording layer to be reproduced next is the second layer, the identifier of the second layer, “0001”, is recorded into the fourth recording layer.

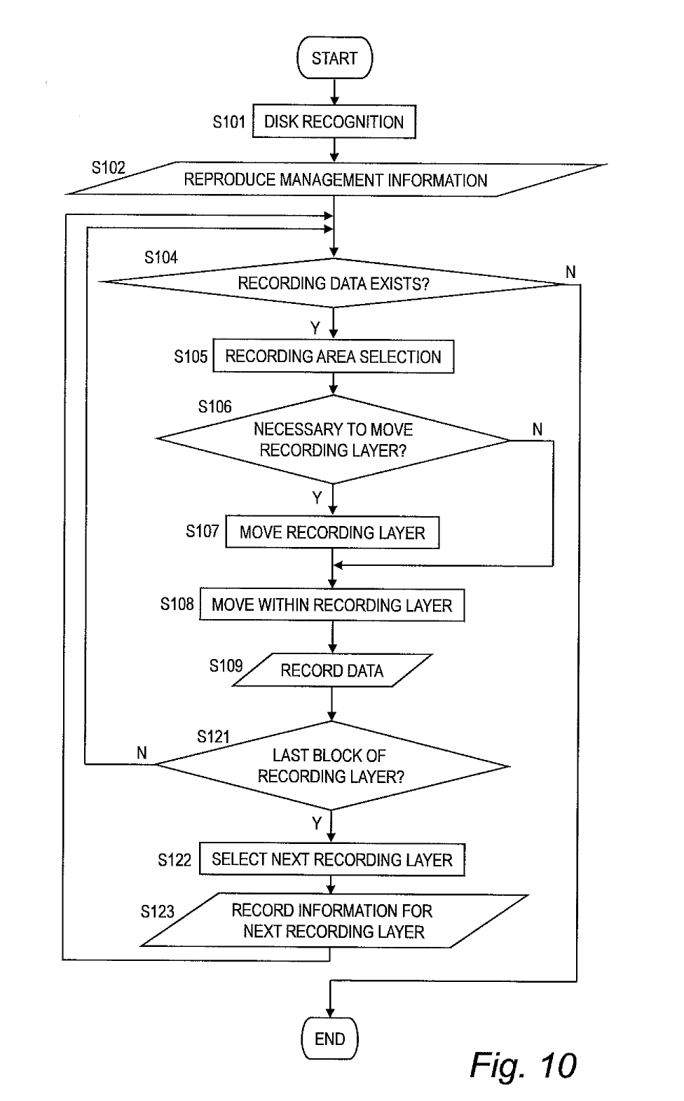

FIG. 10 shows a modification example of the first embodiment of the present invention, and is a flow chart of the processing in which the optical disk device 116 records the information on the next recording layer in the last of each recording layer.

Unlike the processing shown in FIG. 2, in this modification example, the sequence of the recording layers recorded data is recorded after the data recording regions for each recording layer.

The control module 106 recognizes that the optical disk 101 is loaded onto the optical disk device 116 by means of the reflected light of the laser, and determines the type of the loaded optical disk 101 (S101). Thereafter, the management information is reproduced from the management region defined according to the determined type of the optical disk (S102).

Then, the control module 106 determines whether the data which should be recorded into the optical disk 101 is stored in the recording data buffer or not (S104).

If the data which should be recorded into the optical disk 101 is stored in the recording data buffer, the recording region for recording data is selected (S105). Then, the control module 106 determines whether the selected recording region is the storage area in the present recording layer or not (S106). If the recording region exists in another recording layer and it needs to move between the recording layers, the recording layer is moved (S107).

As to the selection of this recording region, if there is a region where user data can be recorded immediately after the region where the data is last recorded, in the recording layer including the region where the data is last recorded (recording layer A), the region is selected. If a recordable region does not exist, another recording layer is selected. If information indicating the next recording layer is recorded in the recording layer A, the recording layer is selected according to this information. If this information does not exist, the recording layer is selected based on several conditions. The first condition is that the recording layer has a spiral direction opposite to the spiral direction of the above-described recording layer A based on the information on the spiral direction of the track in each layer included in the management information reproduced at step S102. The second condition is that the recording layer includes a recordable region where user data can be recorded. The third condition is that the recording layer is closest to the recording layer A among the recording layers satisfying the first and the second conditions.

Then, the data is recorded into the selected recording region (S109). Thereafter, the control module 106 determines whether the block to which the data is to be written is the last block of the user data region in the recording layer or not (S121). If the block to which the data is to be written is not the last block of the user data region in the recording layer, the process returns to step S104 and it is determined whether the data which should be recorded into the optical disk 101 is stored or not.

On the other hand, if the block to which the data is to be written is the last block of the user data region in the recording layer, the recording layer for recording the data next is selected (S122).

Upon selecting the recording layer, the selection is made based on several conditions. The first condition is that the recording layer has a spiral direction opposite to the spiral direction of the above-described recording layer A based on the information on the spiral direction of the track in each layer included in the management information reproduced at step S102. The second condition is that the recording layer includes a recordable region where user data can be recorded. The third condition is that the recording layer is closest to the recording layer A among the recording layers satisfying the first and the second conditions.

Then, next recording layer information which indicates the next selected recording layer is written in the first block of the next management region of the user data region (S123).

It is noted that the next recording layer information may be recorded into the first block of the management region, may be recorded into the last block of the user data region, and may be recorded between the user data region 703 and the management regions 701, 702. That is, the next recording layer information needs only to be recorded into the region after the region where the user data is written in the recording layer.

If the next recording layer information is recorded into the user data region, only the next recording layer information may be recorded into the last block of the user data region, and usual data may be recorded in the last block of the user data region leaving a predetermined bytes, to record the next recording layer information in the left predetermined bytes.

Moreover, the next recording layer information may be an identifier of the recording layer, and may be relative information such as the number of movements from the present recording layer (e.g., two layers move in the pickup direction from the present recording layer).

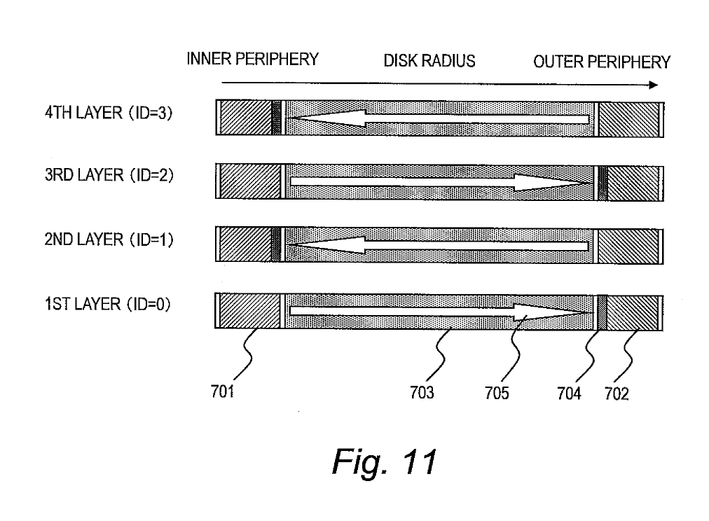

FIG. 11 is a diagram illustrating an arrangement of the next recording layer information in the modification example shown in FIG. 10.

The optical disk shown in FIG. 11 includes four recording layers, that is, the first layer (ID=0) to the fourth layer (ID=3), and spiral tracks of opposite directions are formed in two adjacent layers. That is, tracks are formed from the inner periphery to the outer periphery in the first layer and the third layer, and tracks are formed from the outer periphery to the inner periphery in the second layer and the fourth layer.

In each layer, an inner periphery management region 701 is formed in the innermost periphery of the layer, and an outer periphery management region 702 is formed in the outermost periphery of the layer. A user data region 703 is formed between the inner periphery management region 701 and the outer periphery management region 702. It is noted that arrows illustrated in the user data region 703 show the recording direction of the user data.

The next recording layer information 704 is recorded into the first block of the first management region 701 or 702 after the data has been recorded into the user data region 703 of each layer. Specifically, since the data is recorded in the user data region 703 of the first layer and the third layer from the inner periphery to the outer periphery, the next recording layer information 704 is recorded into the innermost block of the outer periphery management region 702. Since the data is recorded in the user data region 703 of the second layer and the fourth layer from the outer periphery to the inner periphery, the next recording layer information 704 is recorded into the outermost block of the inner periphery management region 701.

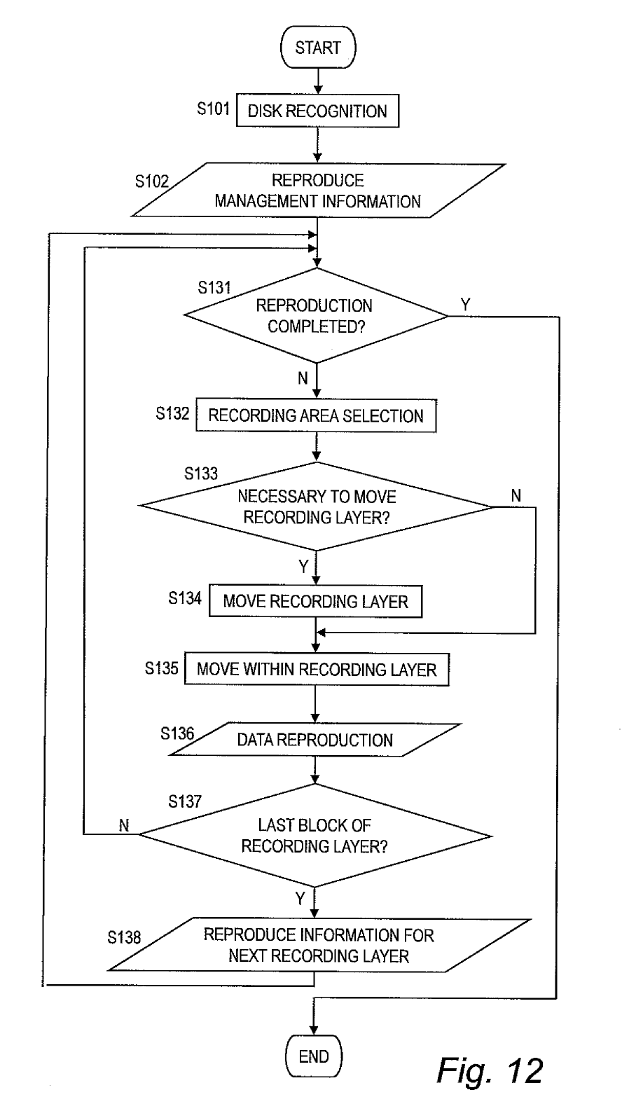

FIG. 12 shows a modification example of the first embodiment of the present invention, and is a flow chart of the processing in which the optical disk device 116 selects the recording layer using the information on the next recording layer of the last recorded recording layer among the recording layers, and reproduces the data in the selected recording layer.

The control module 106 recognizes that the optical disk 101 is loaded onto the optical disk device 116 by means of the reflected light of the laser, and determines the type of the loaded optical disk 101 (S101). Thereafter, the management information is reproduced from the management region defined according to the determined type of optical disk (S102).

Then, the control module 106 determines whether the reproduction of the disk is completed or not depending on whether all of the data of the recording region which has been requested the reproduction from the host is read or not (S131). If the reproduction of the disk is completed, this reproduction processing ends.

On the other hand, if all data which has been requested the reproduction is not read, the recording region for reading data is selected (S132). The layer first selected as the recording region to be reproduced is the first recording region defined in the management information or the recording region which is indicated by the first recording address of the reproduction request from the host, and the first recording layer is determined with this information. Thereafter, information is reproduced continuously in the same recording layer. After reproducing the recording region of the last address in the recording layer, the recording region selected next is a recording region in the recording layer determined in the next recording layer information of the recording layer recorded last.

Then, the control module 106 determines whether it is necessary to move from the selected recording layer to another recording layer or not (S133), and if it is necessity, it is moved to another recording layer (S134). Furthermore, if it is needed to move within the recording layer, the movement is performed (S135).

Then, the data is reproduced from the selected recording layer (S136). Thereafter, it is determined whether the block from which this data is reproduced is the last block in the recording layer or not (S137). If the block reproducing data is not the last block in the recording layer, the process returns to step S131 and it is determined whether the reproduction is completed or not.

On the other hand, if the block from which the data is reproduced is the last block in the recording layer, the next recording layer information 704 is reproduced from the last block in the inner periphery management region 701 or the outer periphery management region 702 (S138). As described above in FIG. 10, in the selection of the recording layer, the next recording layer is determined so that the recording layer of the opposite spiral direction of the track with the present recording layer is selected as the next recording layer.

Thereafter, the process returns to step S131, and the control module 106 determines whether the reproduction is completed or not. If the reproduction of the disk is completed, this reproduction processing ends.

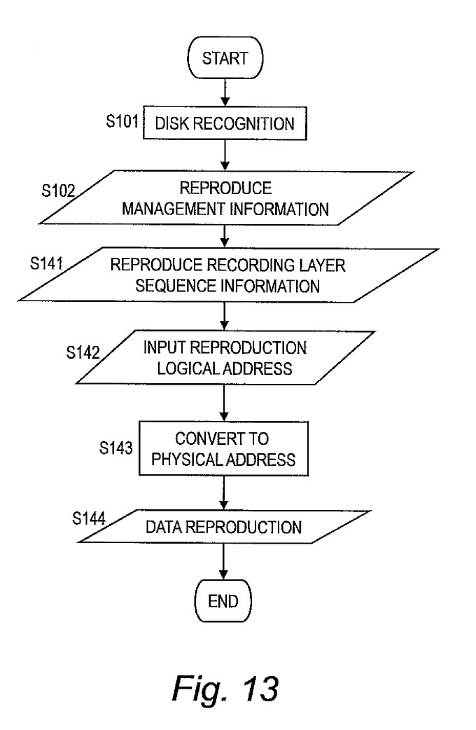

FIG. 13 is a flow chart of the processing in which the optical disk device 116 reproduces the data recorded in the address specified by converting the logical address to the physical address according to the first embodiment of the present invention.

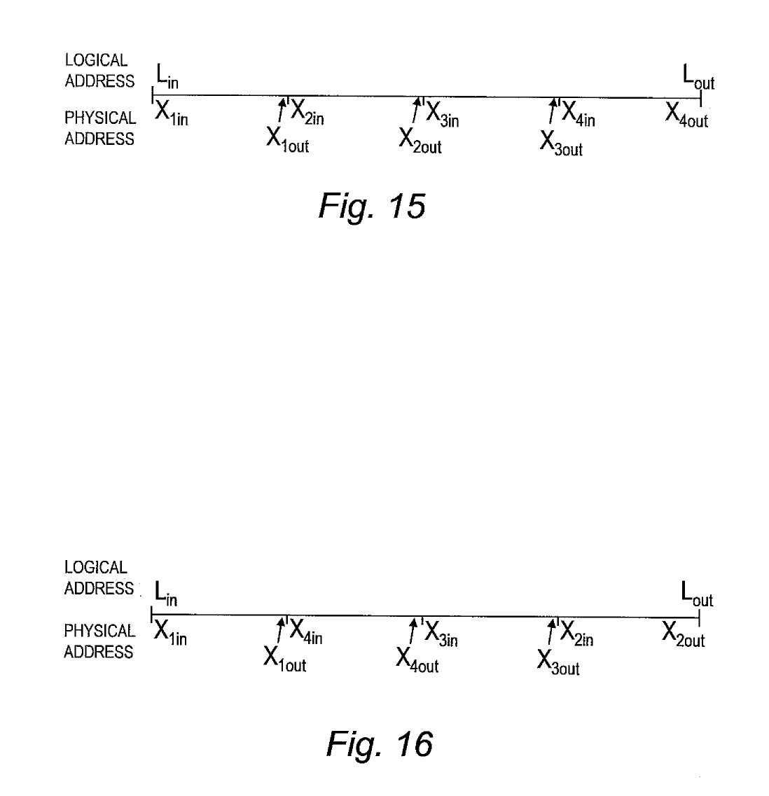

In accordance with the embodiment of the present invention, the reproduction orders of the recording layers may differ for each optical disk. Therefore, if the data recorded in the optical disk is reproduced after converting the physical address assigned to the storage area of the optical disk into the logical address according to the sequence for reproducing the recording layer, it is advantageous in that the address for reproducing the data does not decrease on the way. It is noted that as shown in FIGS. 15 and 16, it is preferable to set an identifier of the recording layer at a first predetermined bit of the physical address.

The control module 106 recognizes that the optical disk 101 is loaded onto the optical disk device 116 by means of the reflected light of the laser, and determines the type of the loaded optical disk 101 (S101). Thereafter, the management information is reproduced from the management region defined according to the determined type of optical disk (S102), and the recording layer sequence information recorded into the predetermined position of the management region is reproduced (S103). This recording layer sequence information (e.g., FIG. 6) indicates the reproduction order of each recording layer included in the optical disk 101.

It is noted that as shown in FIG. 11, in the case where the information on the reproduction order of the recording layer is recorded on each recording layer, even if the management information is not reproduced, it is possible to know the reproduction order of the recording layer by reproducing the data of the management region in each layer.

Thereafter, based on the acquired recording layer sequence information, the offset value of the physical address is determined for each layer. It is noted that the logical address which is added the offset value of the physical address may be derived to generate the mapping information corresponding to logical/physical addresses.

Thereafter, the offset value is subtracted from the logical address specified by the data reproduction request, and the subtracted result is converted into a physical address (S143), and the data specified by the converted physical address is reproduced (S144).

Thus, by specifying the reproduction position by the logical address, even if the reproduction order and the sequence of the physical address do not match, it is possible to reproduce the data recorded in the disk as in the usual multi-layer disk.

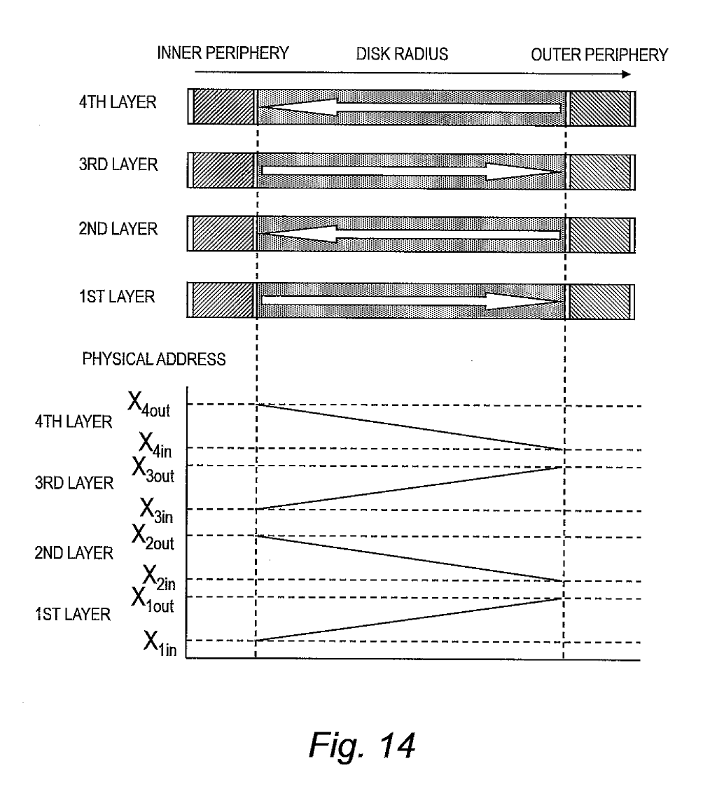

FIG. 14 is a diagram illustrating a conversion of the address of the optical disk device according to the first embodiment of the present invention.

Irrespective of the spiral direction of the track in the recording layer, the physical address given to the storage area of each recording layer of the optical disk is given so that it becomes large in the recording direction. For this reason, in the first layer and the third layer from which the data is reproduced from the inner periphery to the outer periphery, the address of the outer periphery becomes large. On the other hand, in the second layer and the fourth layer from which the data is reproduced from the outer periphery to the inner periphery, the address of the inner periphery becomes large.

For this reason, in the optical disk in which the recording layers having different spiral directions of the tracks are included, it is desirable to associate a physical address with a logical address for the management.

FIG. 15 is a diagram illustrating the correspondence between a logical address and a physical address in case where the data in the recording layer is reproduced in the sequence of the first layer, the second layer, the third layer, followed by the fourth layer, in the case shown in FIG. 14.

The first logical address Lin corresponds to the first address X1in in the first layer. The first address X2in in the second layer corresponds to the next logical address of the logical address corresponding to the last physical address X1out of the first layer. Similarly, the physical address in the second layer, the third layer, and the fourth layer corresponds to the logical address, and last address X4out of the fourth layer corresponds to the last logical address Lout. It is noted that the logical address may not be continuous between the layers (it may be discrete).

FIG. 16 is a diagram illustrating the correspondence between the logical address and the physical address in case where the data in the recording layer is reproduced in the sequence of the first layer, the fourth layer, the third layer, followed by the second layer, in the case shown in FIG. 14.

The first logical address Lin corresponds to the first address X1in the first layer. The first address X4in in the fourth layer corresponds to the next logical address of the logical address corresponding to the last physical address X1out of the first layer. Similarly, the physical address of the fourth layer, the third layer, and the second layer corresponds to the logical address, and the last address X2out in the second layer corresponds to the last logical address Lout. It is noted that the logical address may not be continuous between each layer in this case also (it may be discrete).

Although the conversion between the physical address and the logical address illustrated in FIGS. 15 and 16 may be done using logical/physical address conversion table, the conversion may be done by calculation using methods exemplified in the following.

That is, as to the recording layer recorded from the inner periphery to the outer periphery (the first layer and the third layer), the logical address and the physical address are associated by the following expressions.

X1in=XL1+XAin)

X1out=XL1+XAout

X3in=XL3+XAin

X3out=XL3+XAout

Here, XL1 is a portion of the physical address, indicating the first layer (e.g., an identifier of the first layer), and XL3 is a portion of the physical address, indicating the third layer (e.g., an identifier of the third layer). For example, the higher 2 bits of the physical address is assigned a portion indicating the layer. XAin is a portion of the physical address, indicating the first block in the recording layer, and XAout is a portion of the physical address, indicating the last block in the recording layer.

Moreover, as to the recording layer recorded from the outer periphery to the inner periphery (the second layer and the fourth layer), the logical address and the physical address are associated by the following expressions.

X2in=XL2+XBin

X2out=XL2+XBout

X4in=XL4+XBin

X4out=XL4+XBout

Here, XL2 is a portion of the physical address, indicating the second layer (e.g., an identifier of the second layer), and XL4 is a portion of the physical address, indicating the fourth layer (e.g., an identifier of the fourth layer). For example, the higher 2 bits of the physical address is assigned a portion indicating the layer. XBin is a portion of the physical address, indicating the first block in the recording layer, and XBout is a portion of the physical address, indicating the last block in the recording layer.

That is, the portion of the physical address indicating the layer is assigned to higher order bit(s), and the portion indicating the address in the layer is assigned to lower order bit(s), and thereby, the following expressions hold true.

XL3>XL1>(XAout−XAin)

XL4>XL2>(XBout−XBin)

For example, in the case shown in FIG. 15, the logical address corresponding to X2in is expressed with XL2+XBin. On the other hand, in the case shown in FIG. 16, the logical address corresponding to X4in (corresponding to X2 in of FIG. 15) is expressed with XL4+XBin. That is, in the case where the sequence of the reproduction of the second layer and the fourth layer is switched, the address can be changed by switching XL2 and XL4.

As described in the above, in accordance with the first embodiment of the present invention, if the data is reproduced continuously, the recording layer having a track of opposite spiral direction is selected as the recording layer to be reproduced next, and thereby, there is not a big movement of the pickup during the move between the layers (movement in the radial direction being the minimum), and it is possible to reduce time for the writing of the data. Moreover, the big movement of the pickup is eliminated during the reproduction, and it is possible to reduce the capacity of the data buffer for temporarily storing the data read from the optical disk.

### Second Embodiment

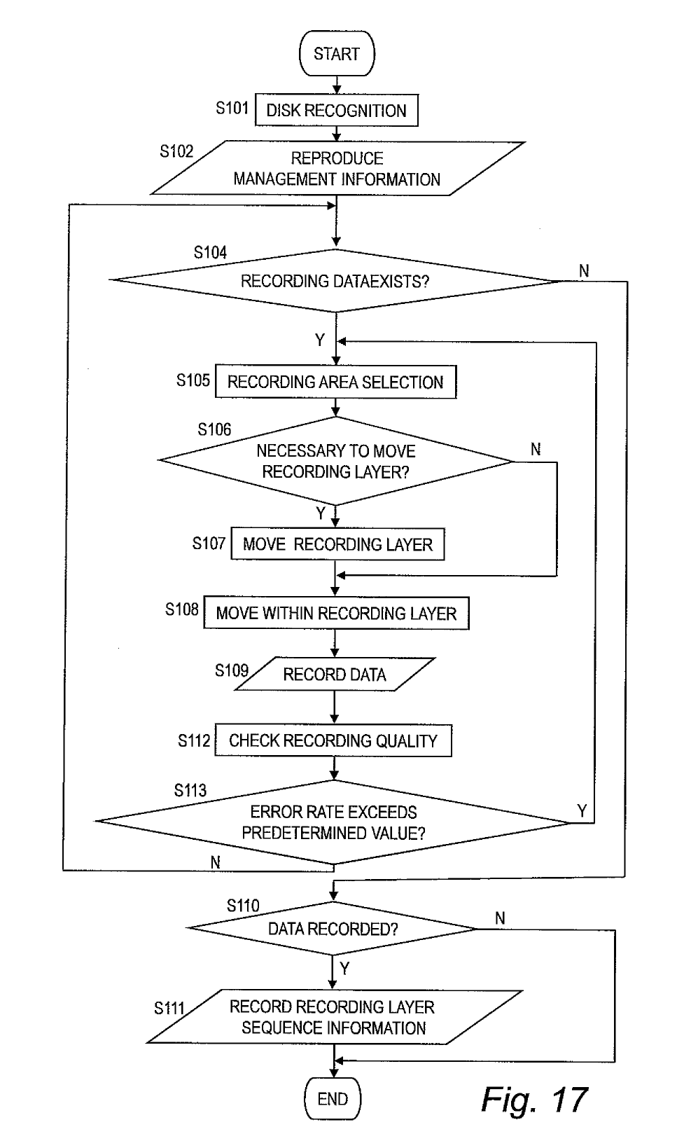

FIG. 17 is a flow chart of the processing for selecting the recording layer based on the recording quality during the recording by the optical disk device 116 according to the second embodiment of the present invention.

Unlike the first embodiment described above, in the second embodiment the recording layer is selected by the recording quality measured during the recording irrespective of information on the defective layer which has been recorded in the optical disk 101 in advance.

The control module 106 recognizes that the optical disk 101 is loaded onto the optical disk device 116 by means of the reflected light of the laser, and determines the type of the loaded optical disk 101 (S101). For example, it is possible to determine the depth of the recording layer, that is, the type of optical disk, from the position where the reflected light can be obtained by moving the objective lens 102 with the moving module 103. Thereafter, the management information is reproduced from the management region defined according to the determined type of optical disk (S102).

Then, the control module 106 determines whether the data which should be recorded into the optical disk 101 is stored in the recording data buffer (S104).

If the data which should be recorded into the optical disk 101 is stored in the recording data buffer, the recording region for recording data is selected (S105).

As to the selection of this recording region, if there is a region where user data can be recorded immediately after the region where the data is last recorded, in the recording layer including the region where the data is last recorded (recording layer A), that region is selected. Upon selecting the recording layer, the selection is done based on several conditions. The first condition is that the recording layer has a spiral direction opposite to the spiral direction of the above-described recording layer A based on the information on the spiral direction of the track in each layer included in the management information reproduced at step S102. The second condition is that the recording layer includes a recordable region where user data can be recorded. The third condition is that the recording layer is closest to the recording layer A among the recording layers satisfying the first and the second conditions.

Thereafter, the control module 106 determines whether it is necessary to move the recording layer from the selected recording layer to another recording layer (S106), and if necessary, it is moved to another recording layer (S107). Furthermore, if it is needed to move within the recording layer, it is moved within the recording layer (S108).

Then, the data is recorded into the selected recording region (S109). Thereafter, the recorded data is read to check the recording quality (S112). Then, the error rate of the read data is compared with a predetermined threshold (S113). If the error rate does not exceed the predetermined threshold, the process moves to step S104 and it is determined whether there is any data which should be further recorded.

On the other hand, if the error rate exceeds the predetermined threshold, it is determined that the recording layer is unavailable and the process proceeds to step S105 to select another recording layer without using the unavailable recording layer. In this case, the recording layer having the same spiral direction with the recording layer determined as unavailable is selected as the recording layer.

Then, it moves to the recording region of the newly selected recording layer (S107, S108), and the data is recorded again (S108).

On the other hand, if it is determined that the data which should be recorded into the optical disk 101 is not stored in the recording data buffer in step S104, it is determined whether the data has been newly written in this optical disk 101 (S110), and if the data has been written, the recording layer sequence information which indicates the sequence for recording the data into the recording layer is recorded into the management region (S111). It is noted that although the recording layer sequence information is written after the recording of all data is completed (e.g., immediately before the disk ejection) in the processing shown in FIG. 17, the recording layer sequence information may be written for each fixed amount of the recording (e.g., one recording layer).

It is noted that if the information on the next recording layer is recorded in each recording layer (refer to FIG. 10), since the sequence of the recording layers changes after it is determined that the error rate is bad, it is necessary to rewrite the information on the next recording layer, which has been recorded into the previous layer. It is noted that information already written cannot be corrected in a write-once type optical disk 101, it is advantageous if the information which makes the previous information invalid is written in the management region. Moreover, a plurality of pieces of information on the next recording layer may be written to make the information written later valid.

Furthermore, although the error rate of the data is used as an index of the recording quality in FIG. 17, it is not limited to such a method. For example, the recording quality may be determined using index such as the amplitude and the jitter of the reproducing signal.

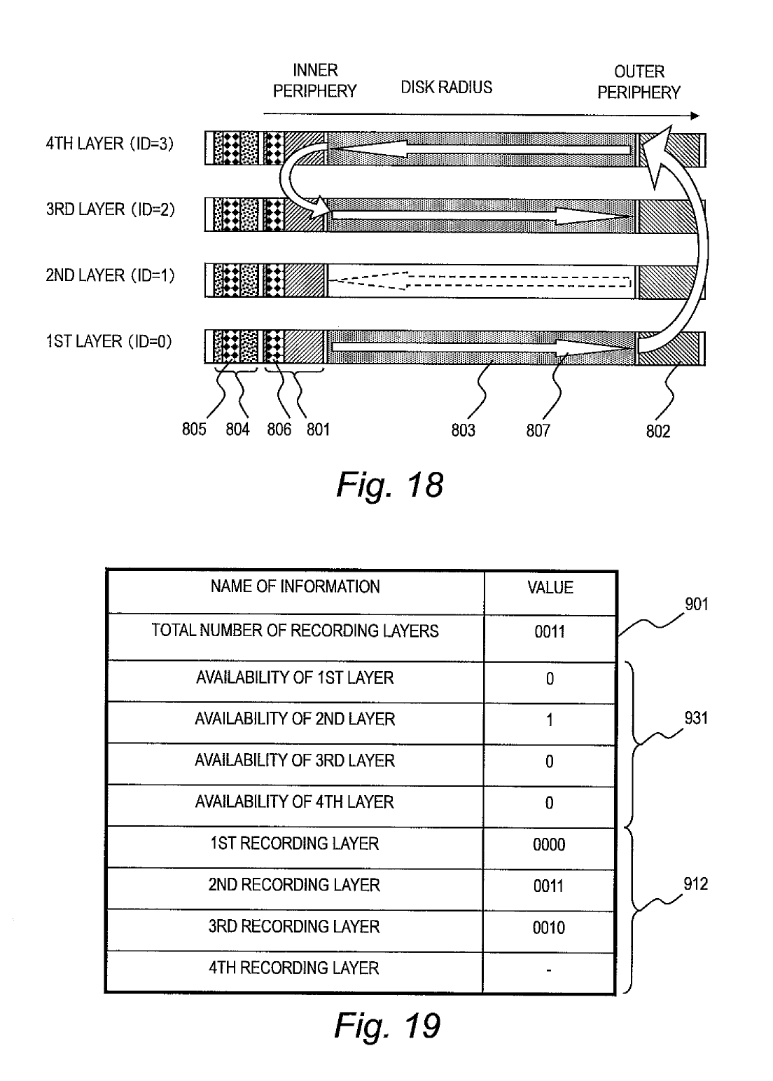

FIG. 18 is a diagram illustrating the sequence of the recording into the optical disk according to the second embodiment of the present invention. FIG. 19 is a diagram illustrating the recording layer sequence information according to the second embodiment of the present invention.

FIG. 19 shows an example of the recording layer sequence information on the optical disk of which the first layer, the fourth layer, and the third layer of the recording layers are used, and the second layer is made unavailable, as shown in FIG. 18.

The recording layer sequence information shown in FIG. 19 includes the information on the total number of the recording layers 901, and the information on the availability of each recording layer 931.

The information on the total number of the recording layers 901 consists of for example, 4-bit data, and “0000” is recorded if there is one recording layer included in the optical disk, and “0011” is recorded if there are four recording layers included in the optical disk.

As for the information on the availability of each recording layer 931, “0” is recorded if the recording layer is available and “1” is recorded if the recording layer is unavailable.

For example, since four recording layers are included in the optical disk shown in FIG. 18, “0011” is recorded into the information on the total number of the recording layers 901. Moreover, since the first layer, the third layer, and the fourth layer are available, “0” is recorded in the information on the availability of each recording layer 931 for these recording layers, and since the second layer is unavailable, “1” is recorded into the information on the availability of each recording layer 931 for the second layer.

As described above, in accordance with the second embodiment of the present invention, the data is recorded by selecting the recording layer having the same spiral direction of the track with the defective layer even if a defective layer is included in the optical disk, and thereby, there is not a big movement of the pickup during the reproduction, and it is possible to reduce the capacity of the data buffer for temporarily storing the data read from the optical disk.

While the present invention has been described in detail and pictorially in the accompanying drawings, the present invention is not limited to such detail but covers various obvious modifications and equivalent arrangements, which fall within the purview of the appended claims.

What is claimed is:

1. An optical disk device for writing data into a disk including a plurality of recording layers, wherein
the disk includes a recording layer in which a track for recording the data is formed in a clockwise spiral direction, and a recording layer in which a track for recording the data is formed in a counter-clockwise spiral direction; and
the optical disk device records the data into a first recording layer, and selects a layer in which the data can be recorded and of which a spiral direction is opposite to the spiral direction of the first recording layer, as a recording layer for recording the data next to the first recording layer.

2. The optical disk device according to claim 1, wherein the optical disk device selects a layer in which the data can be recorded, of which the spiral direction is opposite to the spiral direction of the first recording layer, and which is in a position closest to the first recording layer, as the recording layer for recording the data next to the first recording layer.

3. The optical disk device according to claim 1, wherein the layer which can record the data includes a user data storage region in which the data is not recorded.

4. The optical disk device according to claim 1, wherein the optical disk device selects a layer which does not have a defect, as the recording layer for recording the data next to the first recording layer.

5. The optical disk device according to claim 1, wherein the optical disk device, in a case where a predetermined error is detected by recording the data in a recording layer, determines not to use the recording layer and selects a recording layer having a same spiral direction with the recording layer in which the error has been detected, and records the data which should be recorded into the recording layer in which the error has been detected into the selected recording layer.

6. The optical disk device according to claim 1, wherein the optical disk device, in a case where recording of the data into each recording layer is completed, records information on a layer in which the data is recorded next, after a user data storage region in the recording layer in which the recording of the data has completed.

7. The optical disk device according to claim 1, wherein the optical disk device records information on a sequence of reproducing the data from the plurality of recording layers, in a management information region provided in the disk.

8. The optical disk device according to claim 1, wherein
the disk includes a second recording layer which has a spiral direction opposite to the spiral direction of the first recording layer, and a third recording layer which has a spiral direction same as the second recording layer and is not adjacent to the second recording layer, other than the first recording layer; and
the optical disk device selects, after recording the data on the first recording layer, the second recording layer as a recording layer for recording the data next to the first recording layer, and selects, if the data cannot be recorded into the second recording layer, the third recording layer as a recording layer for recording the data next to the first recording layer.

9. An optical disk device for reading data from a disk including a plurality of recording layers, wherein
the disk includes a recording layer in which a track for recording the data is formed in a clockwise spiral direction, and a recording layer in which a track for recording the data is formed in a counter-clockwise spiral direction; and
the optical disk device reads the data from a first recording layer, and selects a layer which has a spiral direction opposite to the spiral direction of the first recording layer, as a recording layer for reproducing the data next to the first recording layer, based on management information recorded in the disk.

10. The optical disk device according to claim 9, wherein
the disk is provided with a region where information on a layer for recording the data next is recorded, after a user data storage region in each recording layer, and
the optical disk device selects a layer for reproducing the data next based on information on a layer in which the data is recorded next.

11. The optical disk device according to claim 9, wherein
the disk is provided with a region where information on a sequence of reproducing the data from the plurality of recording layers is recorded, and
the optical disk device generates correspondence information between a physical address on the disk and a logical address based on information on a sequence for reproducing the plurality of recording layers.

12. A multi-layer disk including a plurality of recording layers, comprising:
a recording layer in which a track for recording data is formed in a clockwise spiral direction;
a recording layer in which a track for recording the data is formed in a counter-clockwise spiral direction; and
a region for recording information on the spiral direction of each recording layer.

13. The multi-layer disk according to claim 12, further comprising
a region for recording information on a layer for recording the data next after a user data storage region in each recording layer.

14. The multi-layer disk according to claim 12, further comprising
a region where information on a defect of each recording layer is recorded.
